(19) United States
(12) Patent Application Publication
(10) Pub. No.: US 2021/0298872 A1
(43) Pub. Date: Sep. 30, 2021

(54) DENTAL APPARATUS AND METHOD FOR TOOL TO HANDPIECE COMMUNICATION

(71) Applicant: DENTSPLY SIRONA Inc., York, PA (US)

(72) Inventors: Martin Pfleiderer, Auvernier (CH); Moritz Manderscheid, Darmstadt (DE)

(73) Assignee: DENTSPLY SIRONA Inc., York, PA (US)

(21) Appl. No.: 17/049,602

(22) PCT Filed: Apr. 19, 2019
(86) PCT No.: PCT/US2019/028229

§ 371 Date: Oct. 22, 2020

Related U.S. Application Data
(60) Provisional application No. 62/662,274, filed on Apr. 25, 2018.

(51) Int. Cl. A61C 1/00; A61C 1/12; H01Q 9/04; G06K 7/10

(52) U.S. Cl. CPC A61C 1/0015; A61C 1/12; A61C 2204/005; G06K 7/10366; H01Q 9/0414

(57) ABSTRACT

A device, apparatus and method for enabling communication between a tool and a handpiece through a contactless interface while reducing space requirements for communication antennas of the apparatus. The apparatus comprises a dental tool and a handpiece with a transponder attached to or integrated with the dental tool. The transponder comprises a memory region such as a microchip, which is connected to a transponder antenna. The handpiece also includes a reader which communicates with the transponder through a reader antenna. The antennas as constructed as layers on surfaces of one or more substrates save space.

### CROSS-REFERENCE TO RELATED APPLICATIONS

This application claims the benefit of U.S. Provisional Application No. 62/662,274 filed Apr. 25, 2018, entitled “DENTAL APPARATUS AND METHOD FOR TOOL TO HANDPIECE COMMUNICATION” which is hereby incorporated by reference as if fully set forth herein.

### FIELD OF THE INVENTION

The present application relates generally to an apparatus for endodontic treatment, and, more particularly, to a dental apparatus comprising a tool, drive unit, transponder and reader for non-contact communication between the tool and a complementary handpiece. The communication is achieved by Radio Frequency Identification (RFID) transponder (tag) and reader antennas having a planar multi-layer geometry and oriented orthogonally to the tool's axis of rotation to allow for information transfer at a plurality of rotational angles of the tool. Also discussed herein is a device and a method of using the dental apparatus.

### BACKGROUND OF THE INVENTION

Endodontic treatment is important when pulp, which is the soft tissue inside a root canal, becomes inflamed or infected. The inflammation or infection can be caused by deep decay, repeated dental procedures on the tooth or a crack or chip in the tooth. If pulp inflammation or infection is left untreated, it can cause pain or lead to an abscess. Root canal files used to remove pulp from root canals and files may vary in diameter. A dentist normally starts with the smaller size and gradually increases file diameter in order to keep the procedure non-invasive. After removing the infection and getting rid of the bacteria, the dentist can use files to clean, shape and obturate the root canal.

Accessing, scouting and shaping root canals require a plurality of different drills and files. Each of these may require a specific motor setting for an efficient and safe canal preparation.

EP1531750 discloses a dental drill comprising encodings which can be modified taking into account usage information for the dental drill and which can be stored as data storage elements. EP2233103 discloses a medical or dental handpiece having a coil for inductive energy and/or data exchange. EP1531750 and EP2233103 comprise wire antennas disposed around the tool shaft or a ferrite core and a concentrically positioned coiled reader antenna.

Microsensys transponder mic3® shows an integrated unit of small height where the antenna wafer is directly bonded on the memory chip with the antenna structure being on one side of the silicon wafer only.

Scheduling to write usage data to the memory of a file or tool is difficult because it is not known when a user will eject the file or tool from a handpiece, thereby interrupting the communication between the handpiece and the file or tool.

Moreover, adding transponder and reader hardware to handpieces also necessitates additional spatial volume for the file as well as for the head of the contra-angle which holds the file. Increasing the size of the file and of the head of the contra-angle renders the tool's access to the crown of the tooth, in particular of a molar tooth, more challenging and further limits the dentist's view of the treatment site.

### SUMMARY OF THE INVENTION

Existing limitations associated with the foregoing, as well as other limitations, may be overcome by a dental apparatus comprising a tool, drive unit, transponder and reader for communication between the tool and a complementary handpiece, as well as by a method for using the apparatus. Herein an RFID transponder is attached to a coupling end of a dental tool and a reader antenna is attached to a tool facing part of a tool release button of a handpiece for communication. Through communication between the handpiece and the dental tool, the adjustment of motor settings based on the tool may be automated. Moreover the usage of each tool (for example, total working hours) may be automatically monitored to allow for timely replacement of the tool to avoid overuse and breakage of the tool.

According to an example embodiment herein, an RFID transponder is provided. The RFID transponder has a multilayer planar antenna which is attached to a coupling end of a dental tool. The RFID transponder communicates with a reader which also has a multi-layer planar antenna attached to a tool facing aspect of a tool release button of a handpiece. Both planar antennas are oriented orthogonally to an axis of rotation of the dental tool and the antennas are opposite each other with respect to the tool/file axis. In another embodiment herein, the transponder antenna and the reader antenna have silicon substrates and the reader antenna is attached to a tool release button made of a non-magnetic material such as a polymer. The substrate may be a continuous substrate with no central opening. In another embodiment herein, each antenna comprises turns that are disposed on both sides of a silicon substrate, therefore increasing the total number of turns for the given antenna structure. The substrate may be bonded to a memory chip such as an EEPROM chip. In yet another embodiment herein, each antenna may comprise turns on two or more pieces of substrate. In another embodiment, the reader is a pen reader. In another embodiment, the reader is a table-top reader. In yet another embodiment, the reader is attached as an additional unit to an existing handpiece. In another embodiment, the reader is produced with or embedded in the handpiece.

According to an example embodiment herein, a dental apparatus is provided. The apparatus includes a dental tool and a corresponding handpiece in which the dental tool is inserted. In an embodiment, the apparatus includes a transponder and a reader constructed to exchange data through a contactless interface which is an inductive link. The transponder and reader have antennas wherein the transponder antenna or whole transponder is attached to a coupling end of the dental tool and the reader antenna is attached to a tool facing part of a push button of the handpiece. An end of the dental tool that engages with the handpiece may be constructed to have a round or half-moon shape. A push button may also be maintained in a defined angular position with a washer having a member for engaging the push button.

According to another example embodiment herein, a method for using a dental apparatus is provided. The method includes triggering a communication event by a signal strength change caused by reducing the distance between two antennas. In another embodiment, a method for reading the content of a memory chip on a tool handle through a sterile barrier packaging using a pen reader is disclosed.

The method may be useful for exchanging data between the dental tool/file and the handpiece or pen reader. The exchanged data may include static data unique to a tool such as unique file serial number and file type or dynamic data that may be updated during use of the apparatus such as duration of file use, speed or torque of file and complexity of the canal.

Further features and advantages, as well as the structure and operation of various embodiments herein, are described in detail below with reference to the accompanying drawings.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein and wherein:

FIG. 1 illustrates a system diagram illustrating different portions of the dental apparatus.

FIG. 2 cross sectional view illustrating the head of a dental handpiece holding a file as well as a first antenna inside the tool release button and a transponder on the back end of the file.

FIG. 3 is a bottom view of the inside of the tool release button containing a first antenna on a rectangular substrate.

FIG. 4 is a top view of the back end of a file tool with the transponder having a planar printed antenna on a rectangular substrate. The transponder is disposed on a half-moon shaped back face of the file. It may be embedded into a shallow cavity on the end of the file.

FIG. 5 illustrates an antenna disposed on a silicon wafer with integrated antenna turns on both sides.

FIG. 6 illustrates a first antenna on a substrate having a regular hexagonal shape inside a push button.

FIG. 7 illustrates a second antenna on a substrate having an irregular shape on the end of a file handle with half-moon shaped cross-section.

FIG. 8 is an exploded view of an antenna having integrated turns on two silicon wafers that are bonded to each other.

FIG. 9 is a perspective view illustrating a washer for accommodating a cable and preventing rotation of the tool release button.

FIG. 10 illustrates a file holder inside a sterile barrier bag for autoclaving and a handheld reader having a first integrated antenna coil/metal and reader electronics to communicate with the transponder on a file

FIG. 11 illustrates a reader with flat contact surface

FIG. 12 illustrates a reader with a concave contact surface

FIG. 13 is the view of a multi-file blister packaging inserted into a table-top reader having a first integrated antenna coil/metal and reader electronics to communicate with the transponder on the file.

FIG. 14 is the view of a table-top reader which may communicate with three files in parallel.

FIG. 15 illustrates a computer system of an example embodiment herein

FIG. 16 is a diagram illustrating the control of a motor of the handpiece.

FIG. 17 is another diagram illustrating the control of a motor of the handpiece.

FIG. 18 is a flow chart illustrating a method according to an embodiment herein.

FIG. 19 shows a push button according to an embodiment herein.

FIG. 20 shows a cross section of a transponder according to an embodiment herein

FIG. 21 shows another cross section of a transponder according to an embodiment herein.

FIG. 22 shows a dental tool according to an embodiment herein.

FIG. 23 is an embodiment herein showing a dental handpiece with a contra-angle and motor unit and an inductive link.

Different ones of the Figures may have at least some reference numerals that are the same in order to identify the same components, although a detailed description of each such component may not be provided below with respect to each Figure.

### DETAILED DESCRIPTION OF THE INVENTION

In accordance with example aspects described herein a device, apparatus and method are provided for enabling communication between a tool and a handpiece through a contactless interface while reducing space requirements for communication antennas of the apparatus.

### Transponder, Handpiece and Dental Apparatus

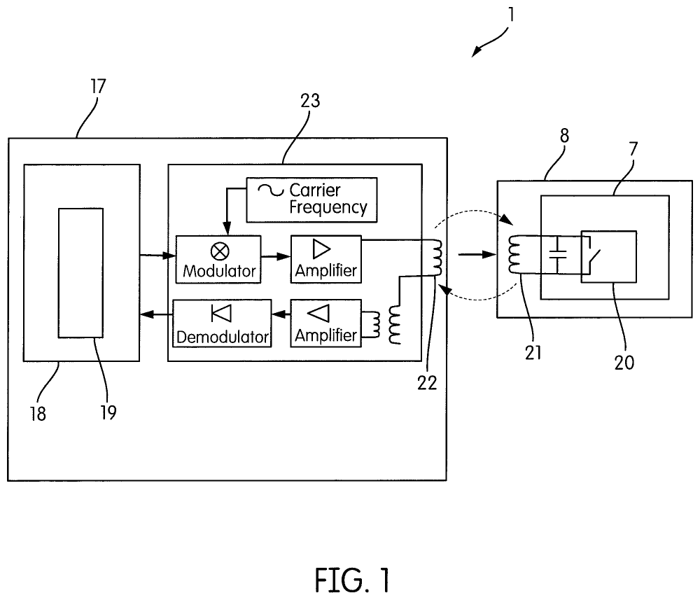

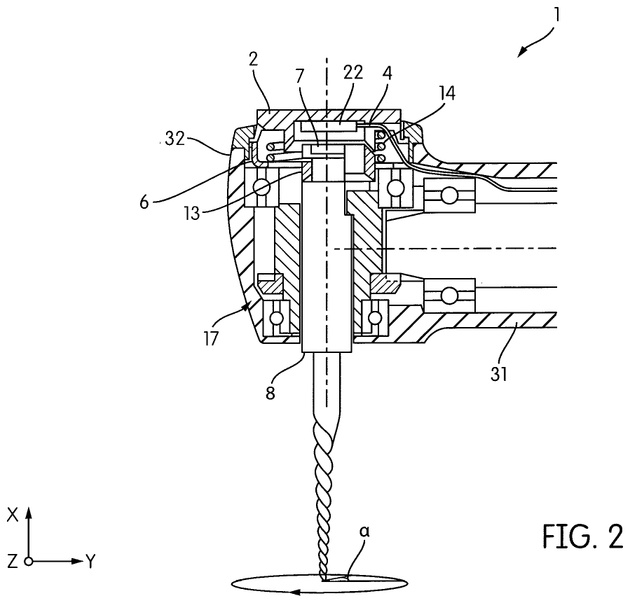

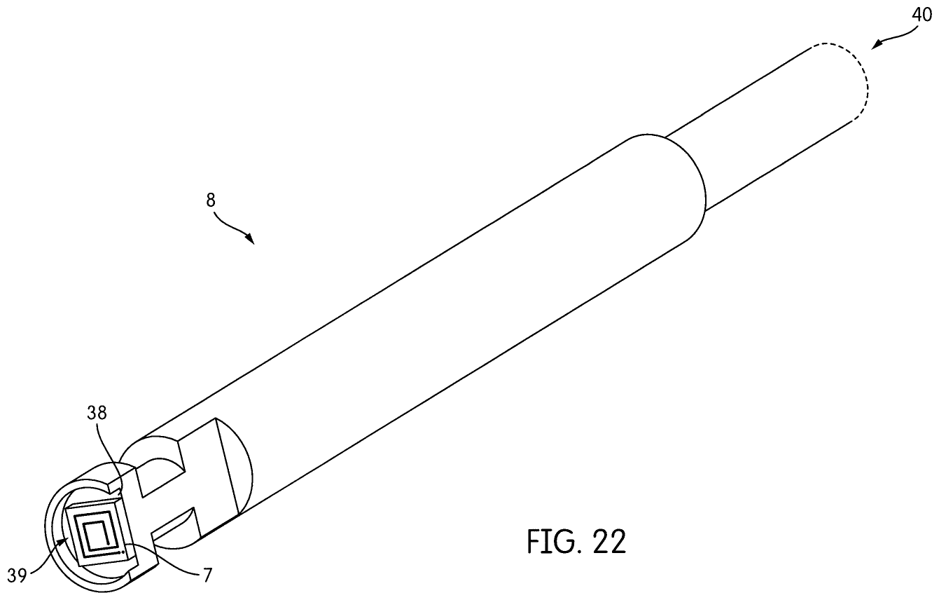

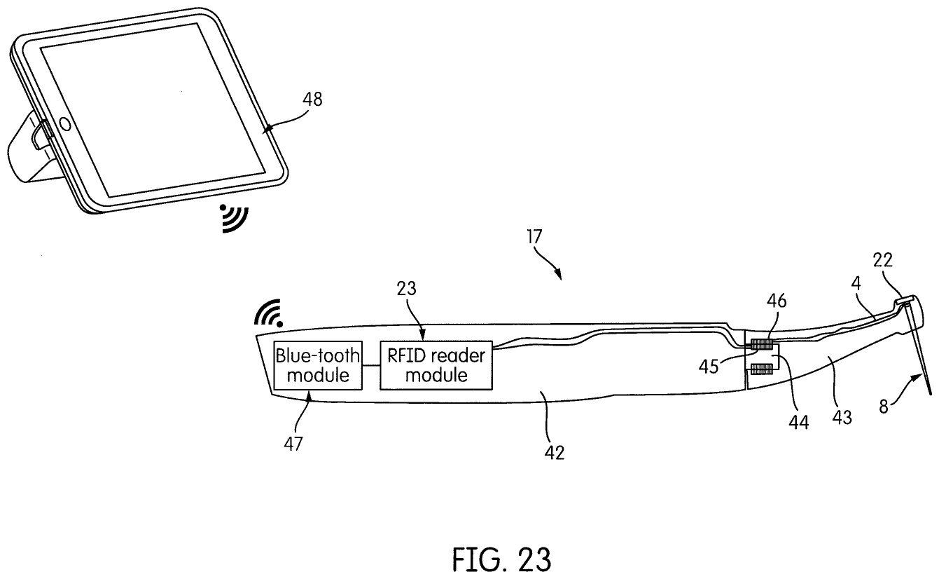

FIG. 1 illustrates a system block diagram of dental apparatus 1 used in endodontic procedures, and which may be constructed and operated in accordance with at least one example embodiment herein. The apparatus comprises a dental tool 8, such as a file, and a handpiece 17. FIG. 22 illustrates the dental tool having a proximal coupling end 39 and a distal treatment end 40 opposite the proximal coupling end 39. The handpiece 17 (FIG. 2) has a head 32 and an outer housing 31. The handpiece also has a drivable hollow shaft constructed to receive the proximal coupling end 39 of the dental tool 8, the drivable hollow shaft being arranged in the head 32 and drivable relative to the outer housing 31 of the head 32 to move the dental tool 8. A transponder 7 is attached to or integrated with the proximal coupling end 39 of the dental tool 8 as shown in FIG. 1 and FIG. 22. The transponder 7 may be snapped, attached and/or bonded into a recess 38 at the proximal coupling end 39 of the tool 8. The transponder 7 may comprise a memory 20 region such as a microchip, which is connected to a transponder antenna 21 (FIG. 2). The handpiece 17 may include a reader 23 which communicates with the transponder through a reader antenna 22. The transponder antenna 21 and reader antenna 22 may face each other and may be oriented orthogonally to the dental tool's axis of rotation X to allow for information transfer at all rotational angles α of the tool. Preferably, transmission of data or energy may take place without any contact through a secure RF link, though not required. The transponder 7 may be a passive transponder which has no energy source and may therefore be maintenance free. Such a passive transponder may be activated by depressing the push button 2 to reduce the distance between the transponder antenna 21 and the reader antenna 22 which increases the signal strength between the two antennas. Pushing the push button 2 may also trigger writing on a memory chip 20 of the transponder before the tool 8 is released from the handpiece 17. The reader 23 may control the routine for communication with the transponder through different function and logic components such as is shown in FIG. 1. A modulator 49 may be used to modulate a carrier frequency with signal data for amplification and transmission to the transponder 7. Data from the transponder 7 may also be received by a reader antenna 22 and transmitted through a transmission means such as a cable 4 or wirelessly, for further processing by the reader circuitry and/or a processor 19 of a digital unit/controller 18. An external data interface may also transmit the data for analysis and further processing by an external computer system such as an iPad (FIG. 23). In an embodiment, the handpiece may be a cordless handpiece. In another embodiment, the handpiece 17 has a housing made from polymer material. The handpiece may further comprise a controller 18, a rechargeable battery (no shown), a power electronic device (not shown), and a motor 33. In an example embodiment herein, the transponder may be configure to be of a small size and fits within the ISO standardized diameter of a file handle (2.35 mm), though other sizes are contemplated. In another embodiment the integrated turns of the transponder antenna and reader antenna are embedded in polymer material to ensure protection from fluids and to provide a di-electric gap from adjacent metal components of the dental apparatus. The whole transponder may also be embedded in polymer material.

In one embodiment herein, the transponder 7 may have a multi-layer planar antenna 21 or the whole transponder 7 attached to the coupling end of a dental tool 8. The reader 23 may also have a multilayer planar antenna 22 attached to the tool facing portion of a push button 2 of the handpiece. Herein, both planar multilayer antennas may be oriented orthogonally to the axis of rotation X of the tool 8 such that no further alignment between the antennas is necessary, for all rotational angles α of the tool 8, to initiate communication or transmit data between the two antennas.

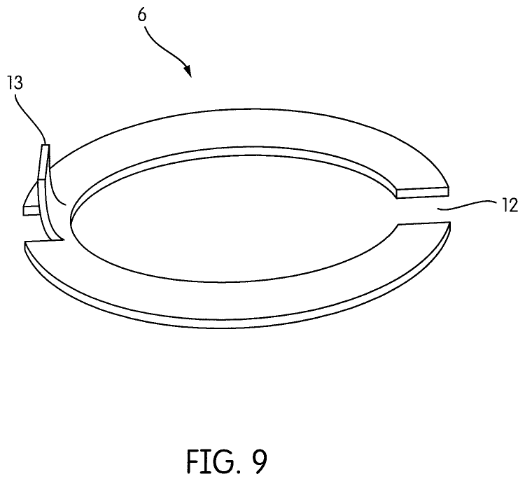

FIG. 1 and FIG. 9 illustrate a washer 6 constructed to keep push button 2 in an angular position to prevent pulling on cable 4. An upright member 13, shown in FIG. 9 engages into a cutout 41 of the push button 2 to keep the angular position of the push button 2 the same and a cut-out 12 provides space for passing the cable 4 inside the handpiece. The transponder antenna 21 is oriented to face the reader antenna 22 such that there is no large empty opening in the center, making them cheaper to produce than the cost of producing antennas with coil windings that create a central opening.

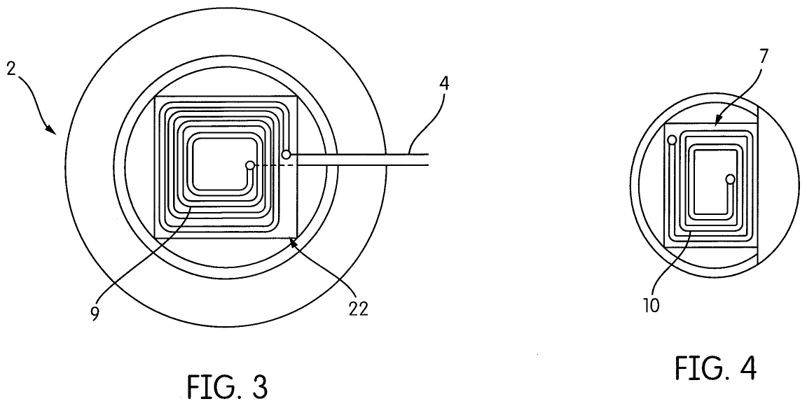

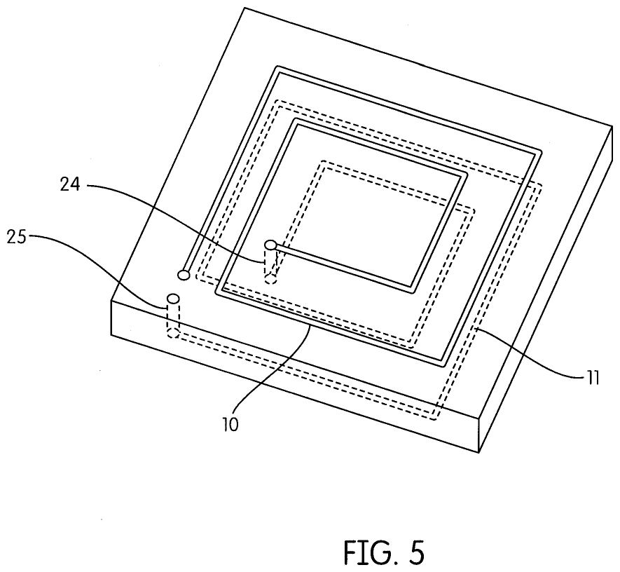

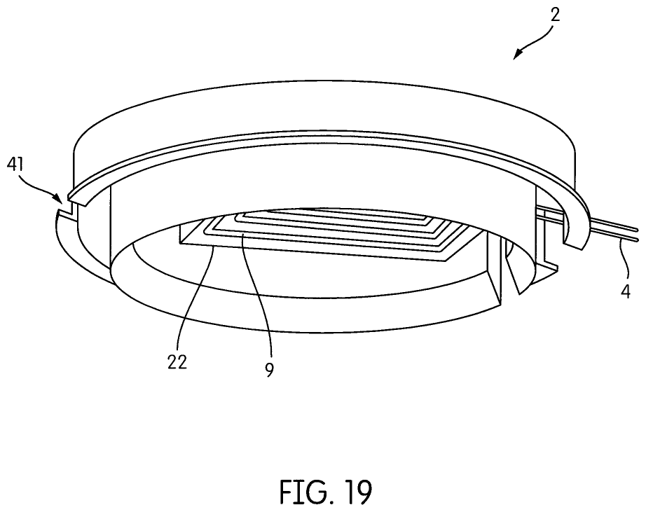

As shown in FIGS. 3 and 4, the reader integrated antenna coil/metal 9 and the transponder integrated antenna coil/metal 10, hereinafter referred to as antenna coil, may be disposed on a silicon wafer or on a printed circuit board (PCB). The silicon wafer allows the creation of small sized antenna structures having a large number of turns. In an embodiment herein, the antenna coils are printed onto a substrate. FIG. 19 shows a perspective view of the push button 2 of FIG. 3 with a cutout on the right to hold the upright member 13 and another cutout on the left to accommodate the cables 4 from the reader antenna 22 having reader antenna coils 9.

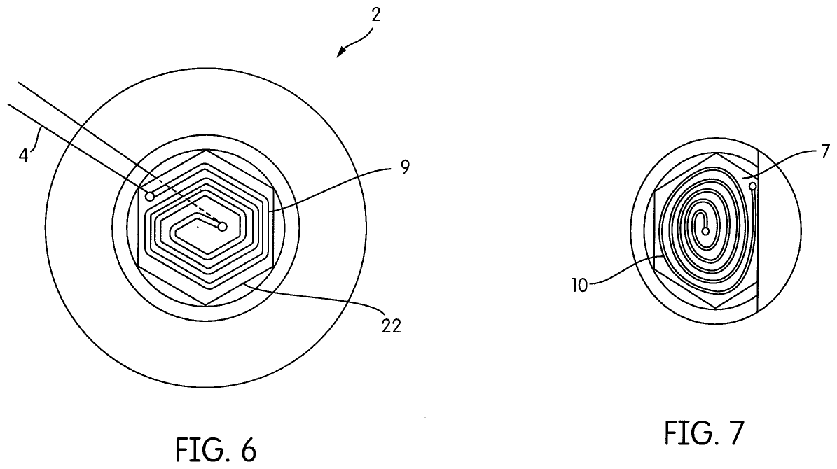

Disposing the antenna coils 10 and 11 on both sides of the wafer, as shown in FIG. 5 allows doubling the number of turns, or for a given number of turns needed, halving the wafer size. A number of coils may be between, for example, 1 and 5 coils. A number of turns may be between, for example, 30 to 100 turns. A number of turns may also be between 50-75 turns. In FIG. 5, antenna coil 10 is on a first side of the wafer and antenna coil 11 is on a second side of said wafer. Herein, a small via 24 (an electrical connection through one or more layers of an antenna), for example a laser cut hole provides a connection from coil 10 on the first side of the wafer to coil 11 on the second side of the wafer. A second via 25 that may also be laser cut provides a connection to guide the coil 11 to the first side of the wafer. Both ends of the combined antenna are on the same side of the wafer and connect directly to a memory chip that is bonded to the antenna chip. A minimum number of total turns is required to reach an appropriate transponder inductance and a target resonant frequency. In a high frequency RFID system, a resonant frequency of 13.56 MHz may be desirable in order to meet international RFID standards.

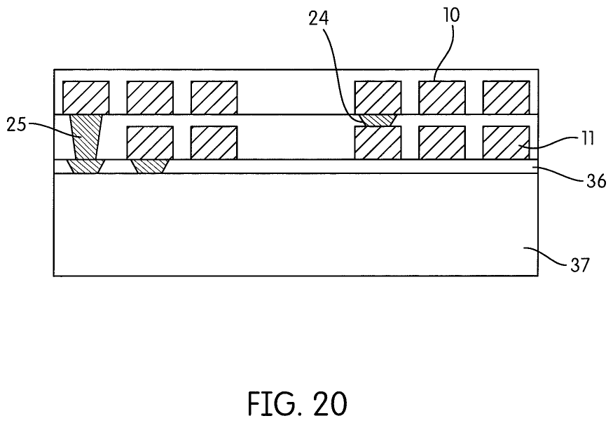

FIG. 20 shows a cross section of an example embodiment of a transponder 7. The transponder 7 has a bottom layer transponder chip 37 and an SiO2 passivation layer 36 with two pads. The antenna coils/metal tracks 10, 11 may be surrounded by dielectric (e.g., polyamide, epoxy resin, or otherwise insulating material). Two vias 24 and 25 connect the layers and a cross-section of the antenna coils or metal tracks 10, 11 may be 10-20 micrometer wide and 15-30 micrometer high. In another example embodiment of the transponder 7 a footprint of the transponder antenna 21 is larger than a footprint of the chip 37. Herein, the transponder antenna 21 may comprise a silicon substrate and two or more layers of metal tracks 10, 11, 35 surrounded by di-electric material and vias 24, 25 to connect the layers.

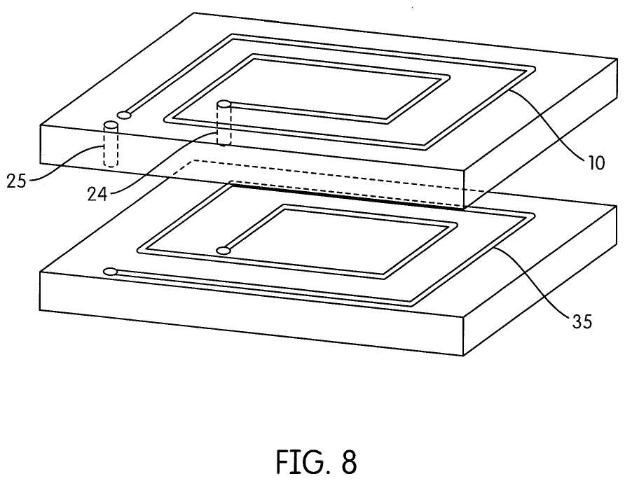

In a further exemplary embodiment herein, the substrate of an antenna may take the shape of a polygon as shown in FIGS. 6 and 7 or other polygonal shape. This allows for maximization of the antenna area within the space available. It is believed that the bigger the antenna area, the longer the attainable communication distance between the transponder antenna 21 and the reader antenna 22. In an example embodiment herein, a distance of, for example, up to 5 mm may be obtained.

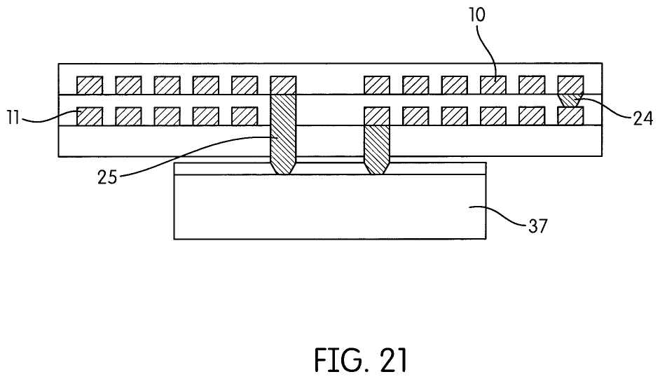

FIG. 8 shows yet another example embodiment wherein an antenna comprises at least two wafers bonded together. Herein a plurality of antenna layers 10, 11, 35 may be created on the sides of the wafers as shown in FIGS. 8 and 20-21.

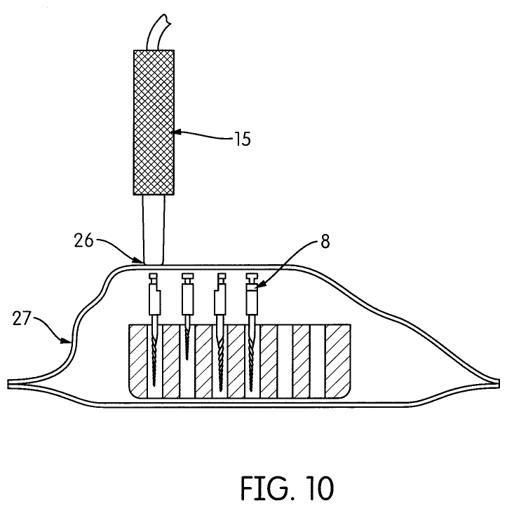

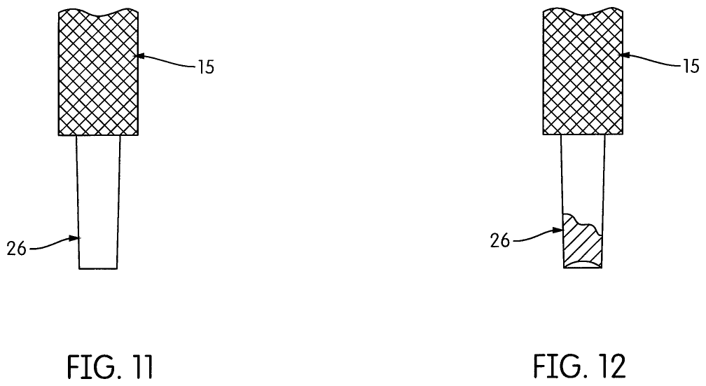

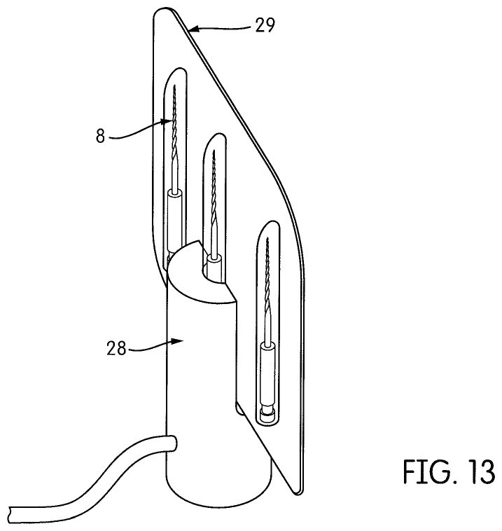

In an exemplary embodiment, a pen style reader 15 may be obtained as shown in FIGS. 10, 11 and 12. The pen style reader 15 may comprise a housing containing reader electronics and a reader antenna. The reader antenna may be located at or near the tip 26 of the pen style reader 15. The pen style reader 15 provides a mechanism to read the contents of a transponder memory 20 in a tool 8 without the need to insert the tool 8 into a handpiece 17. This reader may also be utilized in reading through a conventional sterile barrier bag 27 as used in dental surgeries without compromising on the sterility of tools 8 in the sterile barrier bag 27. Further, for quick and convenient scanning of one tool 8 after another, the tip 26 of the pen style reader 15, may be convex, flat or concave shaped in an example embodiment as shown in FIGS. 11 and 12.

In yet another example embodiment, a table top reader 28 may be provided as shown in FIG. 13. The table top reader 28 may be used in a contactless scan of tools 8 (e.g. files) that are located within a packaging, for example, a thermoformed packaging 29, without contaminating the files. The packaging may be placed upside down in the table top reader 28 such that the antenna 21 of the transponder 7 is as close as possible to a thermoformed cavity of the thermoformed packaging 29 in order to enter a communication range of the reader antenna 22. The tools 8 in the packaging may then be scanned consecutively.

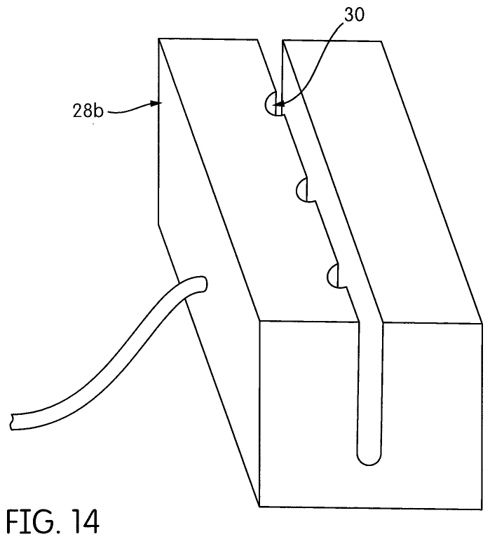

In another embodiment herein, as shown in FIG. 14, a table top reader 28b having reader electronics may be provided with a plurality of slots for receiving a plurality of tools 8 within a multi-file packaging. Herein, more efficient scanning of the plurality of tools 8 may be obtained without the need or substantially without the need to move the multi-file packaging such that all files in the multi-file packaging may be scanned simultaneously. In yet another embodiment an inductive link may be used for a contactless transfer of data between a contra angle 43 of the handpiece 17 and a motor unit 42 of the handpiece 17. Herein, signals from the reader antenna 22 may be transferred to the reader 23 in the motor unit 42 of the handpiece 17 through the inductive link comprising two coils as shown in FIG. 23. In an embodiment, the coils do not contribute to the overall length of the handpiece 17. Herein, the inductive link may comprise a first coil 45 and a second coil 46, with the first coil 45 wound around a drive element 44 of the motor unit 42 and the second coil wound and positioned in the contra angle 43 such that the first coil 45 may be partially or completely nested in the second coil 46. In another embodiment, the first coil 45 may be positioned inside a circumferential groove of the drive element 44 such that an outer diameter of the first coil 45 may be smaller than an outer diameter of the drive element 44 of the motor unit 42. This allows the protection of the coils and their polymer coating from possible damage due to handpiece 17 components contacting the first coil during use and re-processing. In yet another embodiment, the inductive link may be used to supply power to a light source (not shown) of the handpiece 17. A Bluetooth module 47 may also be used to establish wireless communication between the reader 23 and an external device 48 such as an iPad.

### Computer System

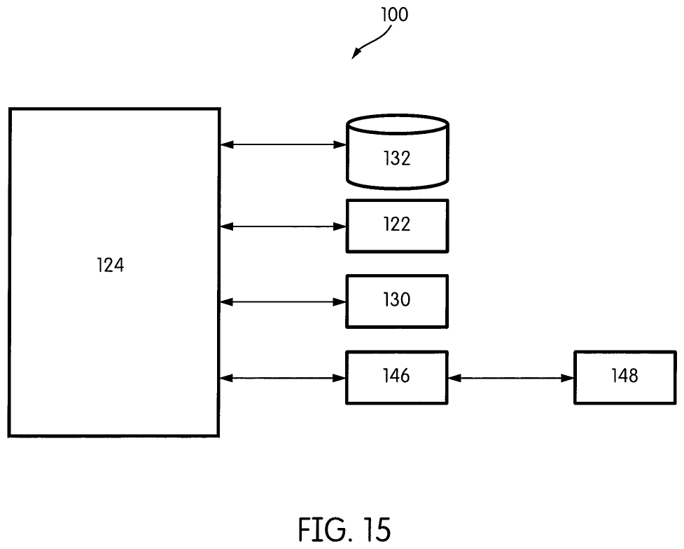

Having described an apparatus 1 for enabling communication between a tool and a handpiece through a contactless or substantially contactless interface using planar multi-layer communication antennas, reference will now be made to FIG. 15, which shows a block diagram of a computer system 100 that may be employed in accordance with at least some of the example embodiments herein. Although various embodiments are described herein in terms of this exemplary computer system 100, after reading this description, it will become apparent to a person skilled in the relevant art(s) how to implement the disclosure using other computer systems and/or architectures of the dental apparatus.

The handpiece housing 31 may be adapted to receive a controller 18 comprising a memory 132 and a processor 122. The controller 18 may be releasably attached and/or located in a port of the handpiece housing 31. The controller 18 may also be located inside a motor unit 42 of the handpiece 17 that may be releasably connected to the handpiece housing 31. Alternatively the controller may be located outside the handpiece 17 for connection to the reader 23 through one of various communication paths such as through a cable, a wireless interface such as Bluetooth, or any signal transmission interface such as an inductive link that is capable of transmitting and receiving signals.

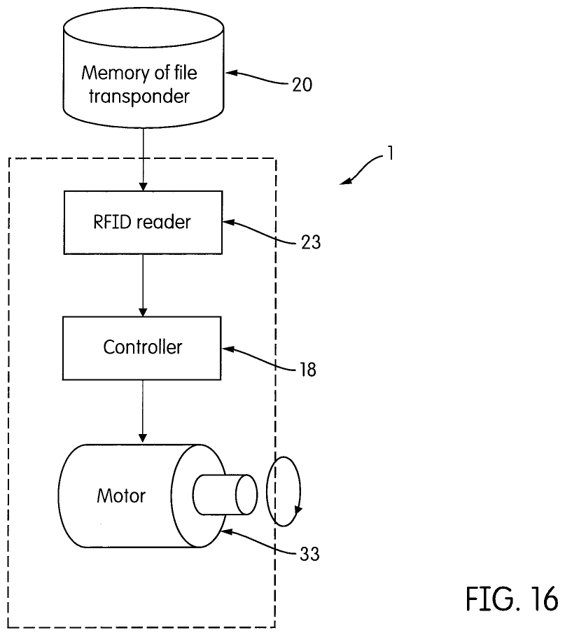

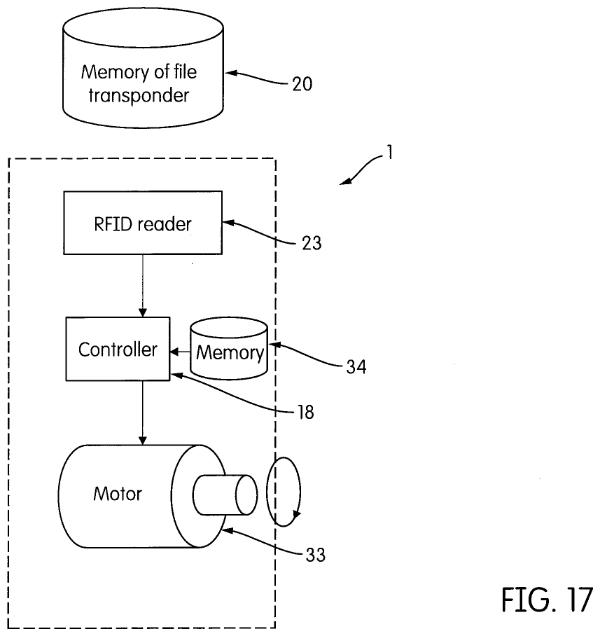

The controller may comprise one or more actuator switches and/or one of more control LEDs (not shown). The controller 18 may be form-fittingly attached to the inside of the housing 31 so that any actuator switch and/or control LED may be positioned inside the housing 31 for outside access and visibility by means of suitable recesses or windows provided in the housing. The switch may be a pressure sensor allowing the practitioner to switch the motor 33 on or off so as to allow a practitioner to interfere with the operation of the dental tool 8 during an endodontic procedure. The controller 18 includes a circuit for control of the motor 33. Accordingly, the processor 122 may analyze pulse width modulated (PWM) signal feedback received from the motor 33 and electronically controls power supplied to the motor 33. The housing comprises windows for providing visibility of LEDs indicating the status of the handpiece 17. The status may relate to the handpiece operation mode, e.g. data exchange with tool ongoing, wireless connection to iPad, rotating or reciprocating mode etc. In one example embodiment herein, as shown in FIG. 16 motor settings may be automatically adjusted through communication between the handpiece 17 and the dental tool. As shown in FIG. 16, the memory of the transponder 20 may hold speed and/or torque data including maximum torque for operation of the motor 33 by the controller 18. Other data that may be automatically monitored include, but are not limited by the number of canals treated (in conjunction with an apex locator), as well as total duration of tool use. In another embodiment as shown in FIG. 17, the memory of the transponder 20 may store the tool type or ID, and a second memory 34 in the handpiece 17 may store the speed and torque, as well as other data for each tool type wherein speed, torque and other data may be updated independently of the supply chain of tool.

In one example embodiment herein, at least some components of the computer system 100 may form or be included in the system of FIG. 1. The computer system 100 comprises the controller 18 which includes at least one processor 122. The processor 122 may be connected to a communication infrastructure 124 (e.g., a communications bus).

The computer system 100 may also include an input unit 130 that may be used by a user of the computer system 100 to send information to the processor 122. In one example embodiment herein, the input unit is an actuator switch and/or control LED. In another embodiment, the controller 18 may be electrically connected to the reader electronics. In another embodiment, the reader electronics may be part of the controller.

The processor 122 may be configured to perform part (or all) of any of the procedures described herein. For example, the processor may be configured to trigger a communication event caused by sensing an increase in signal strength due to a decrease in the separation between the transponder antenna 21 and the reader antenna 21. To execute a procedure, the processor 122 may load the appropriate instructions, as stored on storage device, into memory 132, and then executes the loaded instructions.

The computer system 100 also may include a communications interface 146 that enables software and data to be transferred between the computer system 100 and external devices such as an iPad. The communications interface 146 may include a network interface (e.g., a Bluetooth interface), and the like. Software and data transferred via the communications interface 146 may be in the form of signals, which may be electronic, electromagnetic, optical or another type of signal that is capable of being transmitted and/or received by the communications interface 146. Signals may be provided to the communications interface 146 via a communications path 148 (e.g., a channel).

One or more computer programs or computer control logic may be stored in the memory 132. The computer programs may also be received via the communications interface 146. The computer programs include computer-executable instructions which, when executed by the computer processor 122, cause the computer system 100 to perform the processes as described herein.

Implementation of such a hardware arrangement so as to perform the functions described herein will be apparent to persons skilled in the relevant art(s) in view of this description.

### Method for Operating a Dental Apparatus

Having described the computer system 100 of FIG. 15, the dental apparatus 1 will now be further described in conjunction with methods according to example embodiments herein for enabling communication between a tool and a handpiece through a contactless interface.

In one embodiment, a file may be inserted into the handpiece 17 and the processor 19 may be configured to retrieve file information through the reader electronics by contactless or substantially contactless communication with the file's transponder. In an example embodiment herein, the communication event may be triggered by pushing the push button 2 to cause a change in the signal strength between the reader antenna 22 and the transponder antenna 21. The file information may include the file's serial number and the file usage data. By checking that the retrieved information matches or corresponds to predetermined criteria such as compatibility with the handpiece, cutting safety and efficacy, vibration and noise levels, number of times used, torque value, file head diameter, length of file handle, useful product life time, time to read/write to the memory of the file etc, the inserted file may be allowed for endodontic treatment. In another embodiment, after retrieving file information, the motor settings may be automatically adjusted according to predetermined criteria such as torque speed to enable correct and safe usage.

Further, the processor may be configured to update the file usage data after every use of the file or after the motor 33 stops. It may also be configured to output the usage data through a wireless communication such as Bluetooth to an external computer such as an iPad. Moreover a pen style reader 15 may be employed to read the content of a memory chip on a file transponder through a sterile barrier packaging as shown in FIG. 10.

In view of the foregoing description, it may be appreciated that the example embodiments described herein provide a device, apparatus and method for enabling communication between a tool and a handpiece through a contactless interface using planar multi-layer communication antennas.

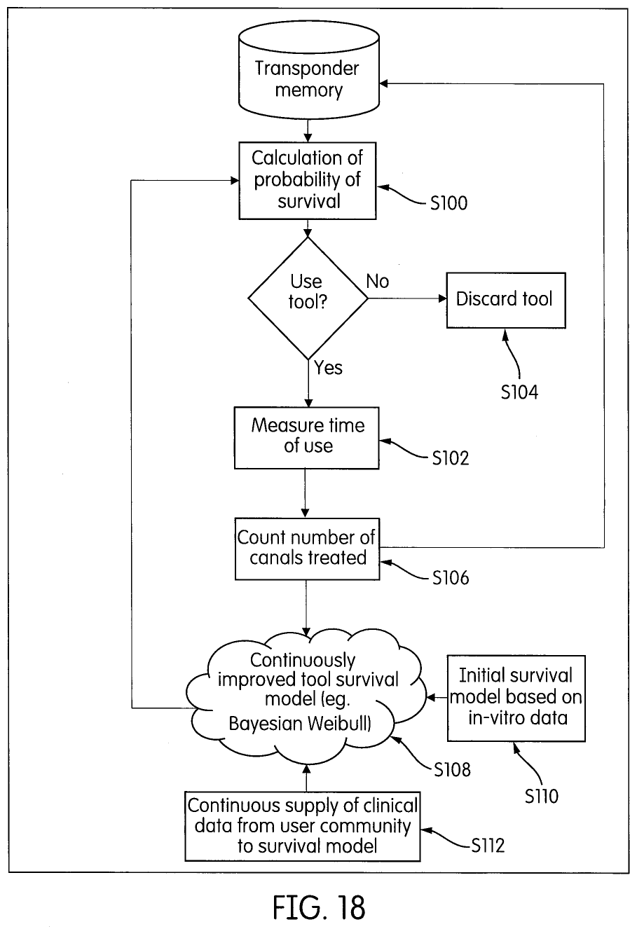

In an example embodiment herein as shown in FIG. 18, a remaining useful life of the dental tool 8 may be estimated based on a survival mode to inform a user when to discard a tool 8. Herein after calculating a probability of survival, Step S100, the dental tool may be discarded, Step S104 if the calculated probability is low. If the probability of survival is high, the treatment may be done and a time of use in the treatment is measured, Step S102 and the number of canals treated is updated, Step S106. Based on an initial survival model using for example, in-vitro data as well as a continuous supply of clinical data, the survival model used in the probability calculation may be improved, Step S108 over time.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The disclosure may be embodied in other specific forms without departing from the spirit or essential attributes thereof, and it is therefore desired that the present embodiments be considered in all respects as illustrative and not restrictive. Any headings utilized within the description are for convenience only and have no legal or limiting effect.

1. A dental tool comprising;
a proximal coupling end;
a distal treatment end opposite the proximal coupling end; and
a transponder including a transponder antenna, the transponder attached to or integrated with the proximal coupling end of the dental tool,
wherein the transponder antenna has a planar multi-layer geometry, and wherein the transponder is constructed such that the proximal coupling end of the dental tool is inserted into a tool receiving shaft of a dental handpiece.

2. The dental tool of claim 1, wherein when the dental tool is coupled with the dental handpiece, the transponder antenna and a reader antenna of the dental handpiece, are oriented orthogonally to an axis of rotation of the dental tool, such that contactless data exchange between the transponder antenna and the reader antenna takes place at all rotational angles of the dental tool.

3. The dental tool according to claim 2, wherein a shape of the proximal coupling end of the dental tool is a round or a half moon shape.

4. The dental tool according to claim 2, wherein transponder antenna comprises a first substrate with antenna turns on both sides of the first substrate.

5. The dental tool according to claim 2, wherein transponder antenna comprises antenna turns on a plurality of substrates bonded to each other.

6. A dental handpiece comprising:
a handheld outer housing;
a head;
a drivable hollow shaft constructed to receive a proximal coupling end of a dental tool, the drivable hollow shaft being arranged in the head and drivable relative to an outer housing of the head to move the dental tool; and
a reader with a reader antenna having a planar, multi-layer geometry, the reader antenna disposed in the head of the handpiece and constructed to send and receive data about the dental tool.

7. A dental handpiece according to claim 6, wherein when the dental tool, is coupled with the dental handpiece, the reader antenna and a transponder antenna of the dental tool, are oriented orthogonally to an axis of rotation, of the dental tool, such that contactless data exchange between the transponder antenna and the reader antenna takes place at all rotational angles of the dental tool.

8. The dental handpiece according to claim 7, wherein the reader antenna includes a second substrate with antenna turns on both sides of the second substrate.

9. The dental handpiece according to claim 7, wherein the reader antenna includes antenna turns on a plurality of substrates bonded to each other.

10. The dental handpiece according to claim 7, further comprising an inductive link constructed to transfer data between the reader and the reader antenna.

11. The dental handpiece according to claim 10, wherein the inductive ink includes:
a first coil and a second coil, and
wherein the first coil is wound around a drive element of a motor unit of the dental handpiece and the second coil is wound and positioned in a contra angle member of the handpiece such that the first coil is nested in the second coil when the contra angle member engages the drive element.

12. The dental handpiece according to claim 11, wherein the first coil is positioned inside a circumferential groove of the drive element such that an outer diameter of the first coil is smaller than an outer diameter of the drive element.

13. The dental handpiece according to claim 7, wherein the reader antenna attached to a tool facing part of a push button of the handpiece and, wherein the push button is maintained in a predetermined angular position using a washer with a member for restricting movements of the push button.

14. A dental tool reader comprising:
a housing;
a member for engaging a dental tool; and
a reader antenna having a planar, multi-layer geometry, the reader antenna disposed in the housing of the dental tool reader and constructed such that the reader antenna and a transponder antenna of the dental tool, are oriented orthogonally to an axis of rotation of the dental tool during a reading, such that contactless data exchange between the transponder antenna in the dental tool and the reader antenna in the dental tool reader takes place at all rotational angles of the dental tool.

15. The dental tool reader of claim 14, wherein the housing is in the shape of a pen and the reader antenna is located at or near a tip of the pen.

16. The dental tool reader of claim 15, wherein the tip of the reader is concave, convex or flat.

17. The dental tool reader of claim 14, wherein the dental tool reader is a table-top reader comprising one or more cavities for reading data from sterile packaged files.

18. The dental tool reader of claim 17, wherein the dental tool reader includes a plurality of cavities and a plurality of reader antennas for simultaneously reading a plurality of dental tools.

19. A method for operating dental handpiece of claim 7, the method comprising the steps of:
providing the dental tool having the transponder;
providing the reader; and
triggering a communication event between the transponder antenna and the reader antenna to retrieve information about the dental tool.

20. The method according to claim 19, further comprising the steps of:
checking that the retrieved information matches or corresponds to predetermined criteria, and
automating the adjustment of motor settings of the dental handpiece based on the retrieved information about the dental tool,
wherein the triggering comprises (i) changing a communication signal strength between the transponder antenna and the reader antenna, said changing being caused by a reduction of the distance between the transponder antenna and the reader antenna or (ii) sending a transponder awakening signal from the reader antenna.

21. A system for operating the dental handpiece of claim 7, the system comprising: at least one processor operable to: trigger a communication event between the transponder antenna of the dental tool and the reader antenna to retrieve information about the dental tool.

22. The system according to claim 21 , further comprising:
checking that the retrieved information matches or corresponds to predetermined criteria, wherein the triggering comprises (i) changing a communication signal strength between the transponder antenna and the reader antenna, said changing being caused by a reduction of the distance between the transponder antenna and the reader antenna or (ii) sending a transponder awakening signal from the reader antenna.
